(19) United States
(12) Patent Application Publication
(10) Pub. No.: US 2002/0178362 A1
(43) Pub. Date: Nov. 28, 2002

(54) Method fo embedding hidden digital watermark into subband-decomposed image for identification of copyrighter

(76) Inventor: Oh-Jin Kwon, Seoul (KR)

Correspondence Address: BACON & THOMAS, PLLC, 4th Floor, 625 Slaters Lane, Alexandraia, VA, 22314-1176, US

(21) Appl. No.: 09/852,041

(22) Filed: May 10, 2001

(51) Int. Cl. H04L 9/00

(52) U.S. Cl. 713/176

(57) ABSTRACT

Disclosed is a method of embedding a hidden digital watermark (also called digital stamp, digital seal, digital signature, etc.) into a produced image which can permanently identify the copyrighter of the produced image to cope with an illegal use or modification thereof by imbedding the hidden digital watermark into the produced image so that the copyrighter can identify his/her authorship when the digital image is first produced by the copyrighter. A color or black-and-white image that only the copyrighter possesses is used as the digital watermark, and the digital watermark is embedded into the produced image in a manner that the human eyes cannot realize the difference between the images before and after imbedding the digital watermark. The method includes repeatedly extending the digital watermark in a symmetric form and adjusting the extended digital watermark image in the same size as an image into which the digital watermark is embedded, subband-decomposing and synthesizing the digital watermark image and the image into which the digital watermark is embedded to produce a final image into which the digital watermark is embedded.

### BACKGROUND OF THE INVENTION

1. Field of the Invention

The present invention relates to a method of embedding a hidden digital watermark into a subband-decomposed image for identification of a copyrighter. In particular, the present invention relates to a method of embedding a hidden digital watermark into a subband-decomposed image which can permanently identify the copyrighter of a produced image to cope with an illegal use or modification thereof by imbedding the hidden digital watermark into the produced image so that the copyrighter can identify his/her authorship or possession when the digital image is first produced by the copyrighter.

In the present invention, it is defined that an image means a still image in the strict sense of the word, and is called an image having a 2-dimensional data structure. Thus, a moving image having a 3-dimensional data structure, i.e., a video, is excluded.

2. Description of the Related Art

Recently, as the use of multimedia contents in various network systems including the Internet is rapidly increasing, the forgery/alteration of digital images is also on an increasing trend. Accordingly, a more reinforced content security is required for identifying the copyrighter of an image product.

Basically, the currently popularized digital image display technique is prescribed to display images using the standard open to the public, and thus any user can freely reproduce, partially extract, or alter the contents of the displayed image. Accordingly, it is difficult in technique to prevent the forgery or alteration of images using the public standard.

According to the existing technique of preventing the forgery/alteration of digital images, the contents are open only to users who can decode the contents, and this restricts the public use thereof. That is, the user should input a password to decode the contents whenever the image is used, and this causes inconvenience in use. Further, if the code is once decoded, the forgery/alteration, reuse, and re-transmission of the image become possible without restriction.

Meanwhile, in order to prevent the illegal use or forgery/alteration of an image product popularly circulated through the Internet and so on, it is preferable to permanently embed a mark of a copyrighter into the contents such as a visual or invisible digital watermark. This technical field for protecting the rights and interests of the copyrighter against the illegal use and forgery/alteration is now in the spotlight. Conditions of the most ideal function pursued by the digital watermarking technique are as follows.

1. Watermark that is not deleted by any attempt of an attacker;

2. Watermark that does not visually damage the original image when embedded;

3. Watermark that copes with an attempt of deleting the embedded watermark or embedding a new watermark in a manner that such an attempt cause a severe damage of the original image;

4. Watermark that has an immunity against a general image processing such as filtering and conversion, re-sampling, re-quantization, re-compression, improvement of the picture quality, adjustment of the illumination and brightness of a color, etc.;

5. Watermark that has an immunity against a geometric distortion such as rotation, translation, cropping, scaling, zooming, etc.;

6. Watermark that can be simultaneously used for a still image, moving image, and even audio;

7. Watermark that can identify one copyrighter without fail when it is extracted from the image; and

8. Watermark effected by a high-speed algorithm so that the embedding or extracting of the watermark is performed in real time.

The digital embedding technique is a new technical field whose partial researches have started just since the latter half of 1990 at home and abroad. Techniques which satisfy only one or two conditions among the above-described conditions have been published by technical experts in the United States, Taiwan, Korea, etc., and patent applications have been filed or registered for a few techniques of this field since 1996 in the United States, Taiwan, Korea, etc.

Any digital embedding technique that satisfies most of the above-described conditions has not yet been published all over the world. Especially, it is expected that an algorithm applicable to an environment public to many and unspecified persons such as the Internet will be possible only after a great technical progress is made from the present level of technique, i.e., after at least one or two-year researches and efforts are made.

### SUMMARY OF THE INVENTION

Therefore, an object of the invention is to solve the problems involved in the related art, and to provide a digital embedding technique which has a superior performance for the above-described 8 conditions except for the third condition in comparison to the existing digital embedding technique that satisfies only a portion of the conditions, that does not have a superior performance per condition, or that can be used only in a limited environment, i.e., only for limited kinds of embedded images.

In accordance with the present invention, this object is accomplished by providing a method of embedding a hidden digital watermark into a produced image which comprises repeatedly extending the digital watermark in a symmetrical form, adjusting an image of the extended digital watermark in the same size as an image into which the digital watermark image is embedded, subband-decomposing and adding the respective images. The digital watermark embedded according to the present invention is not deleted by any attempt of an attacker; does not visually damage the original image when embedded; copes with an attempt of deleting the embedded watermark or embedding a new watermark in a manner that such an attempt cause a severe damage of the original image; has an immunity against a general image processing such as filtering and conversion, re-sampling, re-quantization, re-compression, improvement of the picture quality, adjustment of the illumination and brightness of a color, etc.; has an immunity against a geometric distortion such as rotation, translation, cropping, scaling, zooming, etc.; can be simultaneously used for a still image, moving image, and even audio; can identify one copyrighter without fail when it is extracted from the image; and is effected by a high-speed algorithm so that the embedding or extracting of the watermark is performed in real time.

### BRIEF DESCRIPTION OF THE DRAWINGS

The above object, and other features and advantages of the present invention will become more apparent after a reading of the following detailed description when taken in conjunction with the drawings, in which:

FIG. 1 is a view illustrating a digital watermark embedding method according to the present invention;

FIG. 2 is a view illustrating a step of repeatedly extending a digital watermark in a symmetrical form and adjusting the watermark in the same size as an image according to the present invention;

FIG. 3 is a view illustrating a process of decomposing an image into 2×2 subbands in horizontal and vertical directions according to the present invention;

FIG. 4 is a view illustrating an example of images produced during a process of decomposing an input image into 4×4 subbands according to the present invention; and

FIG. 5 is a view illustrating a process of synthesizing subband images in vertical and horizontal directions.

### DETAILED DESCRIPTION OF THE PREFERRED EMBODIMENT

Hereinafter, a method of embedding a digital watermark into a produced image according to the present invention will be described with respect to a preferred embodiment illustrated in the annexed drawings.

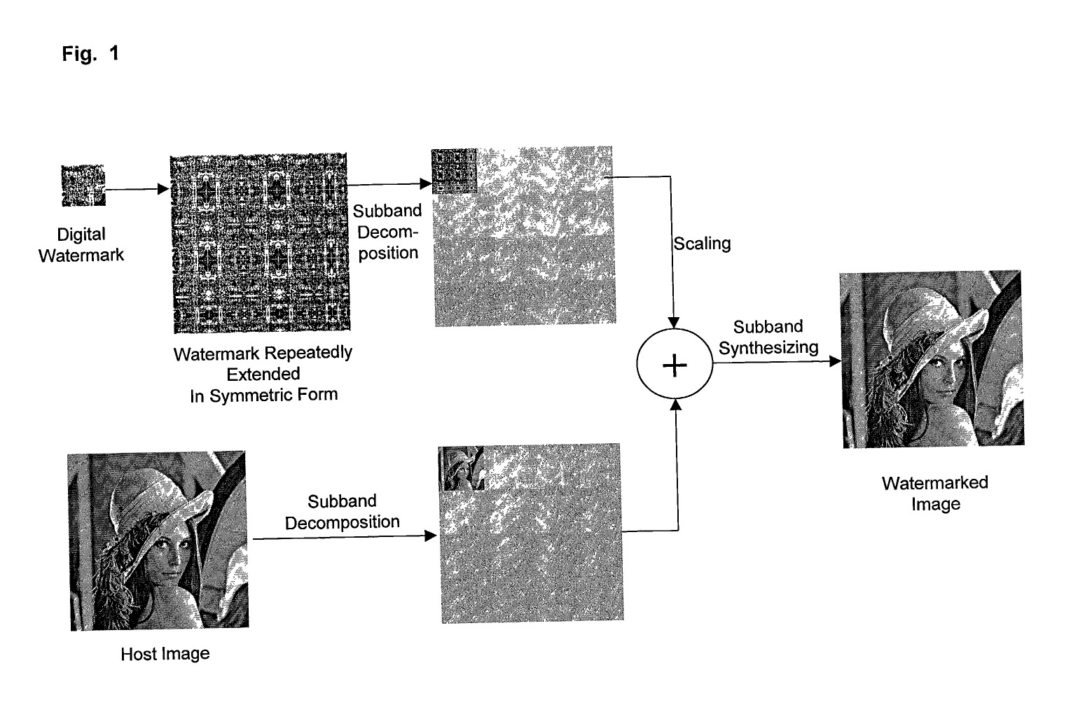

FIG. 1 is a view illustrating a digital watermark embedding method according to the present invention. A color or black-and-white image which only the copyrighter possesses may be used as a digital watermark 1, and the digital watermark is embedded into a produced image in a manner that the human eyes cannot realize the difference between images before and after imbedding the digital watermark 1.

The method of imbedding the digital watermark into the produced image 2 includes the steps of 1) repeatedly extending the digital watermark 1 in a symmetric form and adjusting an image 3 of the extended digital watermark in the same size as an image 2 into which the digital watermark 1 is embedded, 2) subband-decomposing the digital watermark image 3 and the image into which the digital watermark is embedded, 3) properly adjusting pixel values of the subband-decomposed digital watermark image in accordance with the subband-decomposed image into which the digital watermark is embedded, and adding the pixel values of the subband-decomposed digital watermark image to pixel values of the subband-decomposed image into which the digital watermark is embedded, and 4) finally producing an image 4 into which the digital watermark is embedded by a subband synthesis.

The respective step as above will be explained in detail as follows.

1. Step of Repeatedly Extending the Digital Watermark in a Symmetric Form and Adjusting an Image of the Extended Digital Watermark in the Same Size as an Image into which the Digital Watermark is Embedded

The step of repeatedly extending the digital watermark in the symmetric form repeatedly uses an extension in a right direction and an extension in a downward direction and vice versa. The extension in the right direction extends the digital watermark so that the left and right digital watermark images are symmetrical, and the extension in the downward direction extends the digital watermark so that the upper and lower digital watermark images are symmetrical. An extension in a diagonal direction extends the digital watermark by once performing the extension in the right direction and the extension in the downward direction irrespective of its order. The digital watermark image of a 2×2 size that is obtained by once using the extension in the right direction and the extension in the downward direction, i.e., the image extended 4 times in size (i.e., area) in a 2-dimensional plane of the image, is further extended in the same manner to obtain the larger extended digital watermark image. The extension of the digital watermark image as above is repeated until the extended digital watermark image becomes larger than the image into which the digital watermark image is embedded, and the extended digital watermark image is adjusted in the same size as that of the image into which the digital watermark image is embedded by cutting off portions of the digital watermark image that exceed the size of the image into which the digital watermark image is embedded.

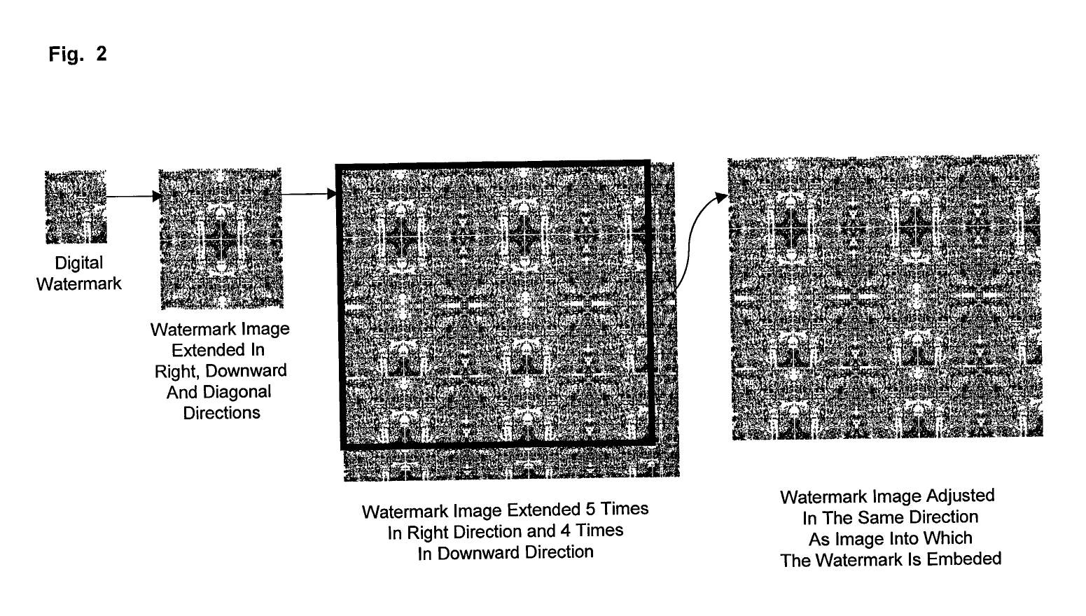

FIG. 2 is a view illustrating a step of adjusting the digital watermark image having a different width and length in the same size as an image into which the watermark is embedded after extending the digital watermark image 4 times in the right direction and 5 times in the downward direction.

2. Step of Subband-Decomposing the Digital Watermark Image and the Image Into which the Digital Watermark is Embedded

The step of subband-decomposing the digital watermark image and the image into which the digital watermark is embedded is performed in a manner that the images are first decomposed into 2 subbands in the horizontal and vertical directions, respectively, and then the decomposed subbands are decomposed again in the same manner in the horizontal and vertical directions. Accordingly, the decomposition into subbands the number of which corresponds to a multiplier of 2, and the decomposition into subbands the number of which corresponds to another multiplier of 2 can be performed.

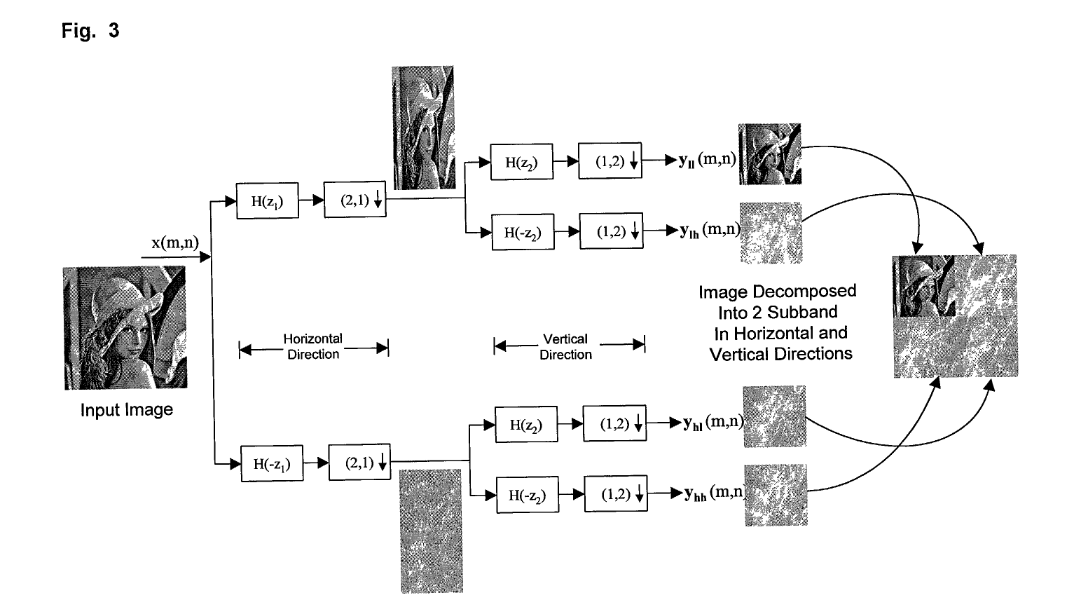

FIG. 3 is a view illustrating a process of decomposing an image into two subbands in horizontal and vertical directions according to the present invention. According to this process, the input image is decomposed into 2×2 subbands, and the decomposed subbands are decomposed in the same manner to obtain 4×4 decomposed subbands. By repeating this process, 2ⁿ×2^{m} (where, n and m are natural numbers) subband decomposition can be effected.

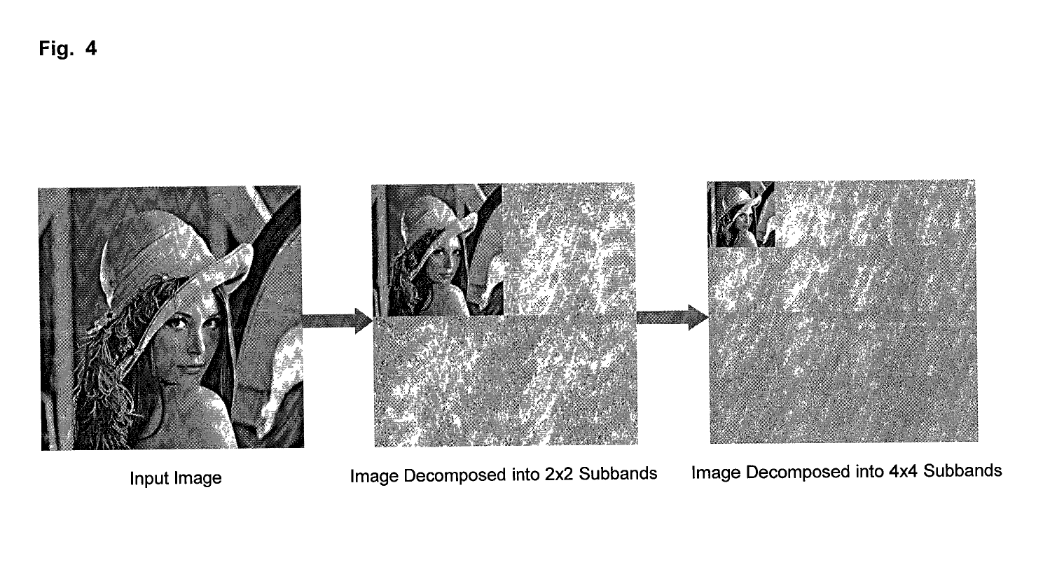

FIG. 4 is a view illustrating an example of images produced during a process of decomposing an input image into 4×4 subbands according to the present invention.

In FIG. 3, H(Z₁) and H(Z₂) denote low-pass filters for low-pass-filtering one-dimensional signal in the horizontal and vertical directions, respectively, and H(−Z₁) and H (−Z₂) denote high-pass filters for high-pass-filtering one-dimensional signal in the horizontal and vertical directions, respectively. (2,1)↓ and (1,2)↓ denote 2:1-reduced sampling in the horizontal and vertical directions, respectively.

In the present invention, the one-dimensional low-pass filters H(Z₁) and H(Z₂) are implemented as follows.

1) It is assumed that the image of one line in the horizontal or vertical direction inputted to the one-dimensional low-pass filter is denoted as X(n), and X(n) has N pixel points. At this time, n has a value in the range of 0 to (N−1).

2) X(n) is extended to Xₑ(n) having the length of (2N−2) by the following equation.

$${x}_{e} ( n ) = \{ \begin{matrix}x ( n ) , & 0 < n < N - 1 , \\ x ( 2 N - 2 - n ) , & N > n > 2 N - 3 ,\end{matrix}$$

3) Xₑ(k) is obtained by performing a discrete Fourier transform (DFT) with respect to Xₑ(n) using the following equation.

$${X}_{e} ( k ) = {\sum }_{n = 0}^{2 N - 3} {x}_{e} ( n ) {e}^{- {j}_{2 N - 2}^{2 kri}}$$

4) The above equation is replaced by Xₑ(k)=0 with respect to k, where N/2≦k≦3N/2-2.

5) An inverse discrete Fourier transform (IDFT) is performed by the following equation, and only the values in the range of 0≦n≦N−1 are taken.

$${X}_{e} ( R ) = {\sum }_{n = 0}^{2 N - 3} {x}_{e} ( n ) {e}^{- {j}_{2 N - 2}^{2 kri}}$$

In the present invention, the one-dimensional high-pass filters H(−Z₁) and H(−Z₂) are implemented by changing the term “4) The above equation is replaced by Xₑ(k)=0 with respect to k, where

$$\frac{N}{2} \leq k \leq \frac{3 N}{2} - {2}^{″}$$

to “The above equation is replaced by Xₑ(k)=0 with respect to k, where

$$0 \leq k \leq \frac{N}{2} - 1 or \frac{3 N}{2} \leq k \leq 2 N - {3}^{″} .$$

3. Step of Properly Adjusting Pixel Values of the Subband-Decomposed Digital Watermark Image in Accordance with the Subband-Decomposed Image into which the Digital Watermark is Embedded, and Adding the Pixel Values of the Subband-Decomposed Digital Watermark Image to Pixel Values of the Subband-Decomposed Image into which the Digital Watermark is Embedded

The step of adding the pixel values of the subband-decomposed digital watermark image to the pixel values of the subband-decomposed image into which the digital watermark is embedded is implemented in consideration of the biological research result of the human visual system model. According to this research result, the human eyes react on the image with different sensibilities in an edge region, homogeneous region, and texture region of the image. According to the present invention, the watermark image and the image into which the watermark is embedded are added at different rates in the three different regions.

If the pixel values of the subband-decomposed digital watermark image is denoted as w(m,n), and the pixel values of the subband-decomposed image into which the watermark image is embedded is denoted as X(m,n), the adding process is denoted as a X (m,n)+(1−α) w(m,n). At this time, α has a value in the range of 0 to 1, and has a different value in the edge region, homogeneous region, or texture region of the image. α may accidentally have the same value in the three regions of the image in the above-described process according to the present invention.

The process of dividing the image into the edge region, homogeneous region, and texture region can be performed using one among various commercialized techniques, and this is not the subject matter of the present invention. However, the adjustment process for using the different α values with respect to the three regions of the image is the subject matter of the present invention.

4. Step of Finally Producing an Image into which the Digital Watermark is Embedded by a Subband Synthesis.

The step of producing the final image into which the digital watermark is embedded by the subband synthesis is performed in the reverse order of the step of subband-decomposing the digital watermark image and the image into which the digital watermark is embedded.

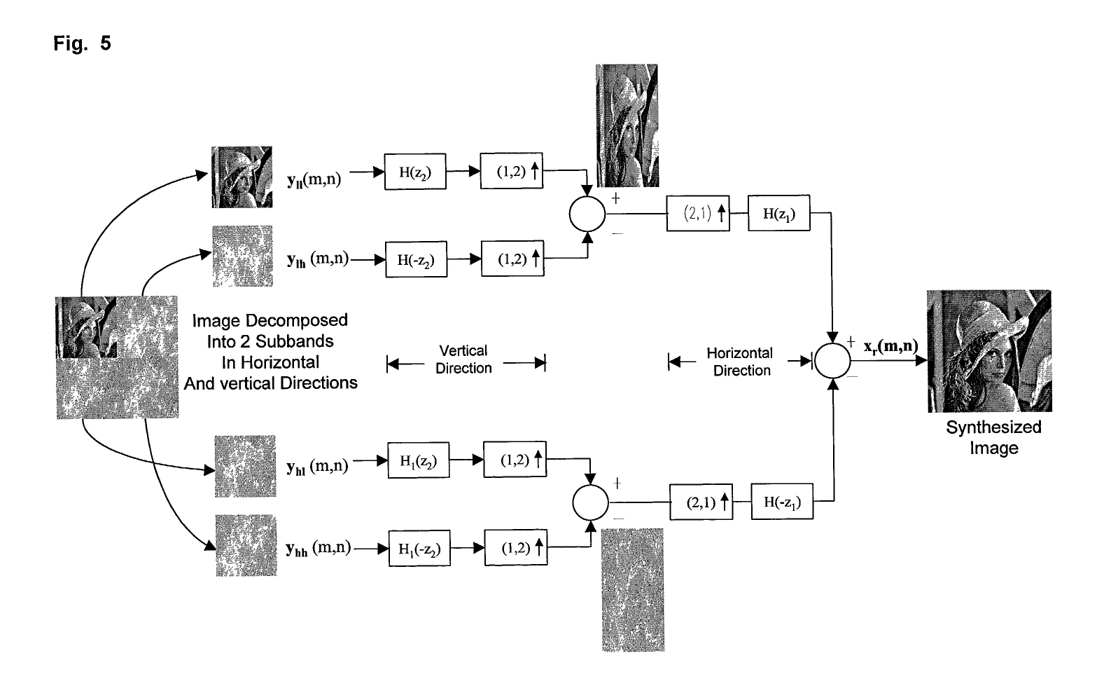

FIG. 5 is a view illustrating the process of synthesizing the subband images in vertical and horizontal directions, which is reverse to the process of repeatedly decomposing an input image into subbands in the horizontal and vertical directions. In FIG. 5, H(Z₁) and H(Z₂) denote low-pass filters for low-pass-filtering one-dimensional signal in the horizontal and vertical directions, respectively, and H(−Z₁) and H(−Z₂) denote high-pass filters for high-pass-filtering one-dimensional signal in the horizontal and vertical directions, respectively. (2,1)↑ and (1,2)↑ denote 1:2-extended sampling in the horizontal and vertical directions, respectively.

5. Watermark Embedding Method in Accordance with the Color Types of the Digital Watermark Image and the Image into which the Watermark Image is Embedded

The watermark embedding method in accordance with the color type of the digital watermark image and the image into which the watermark image is embedded is performed as follows.

1) In case that the digital watermark image is black and white, and the image into which the watermark is embedded is black and white, the above-described method is used as it is.

2) In case that the digital watermark image is black and white, and the image into which the watermark is embedded is color, the image into which the watermark is embedded is converted into a YUV form, and the digital watermark is embedded into the Y component.

3) In case that the digital watermark image is color, and the image into which the watermark is embedded is black and white, the digital watermark image is converted into a YUV form, and the Y component of the digital watermark is embedded into the image into which the watermark is embedded.

4) In case that the digital watermark image is color, and the image into which the watermark is embedded is color, both the digital watermark image and the image into which the watermark is embedded are converted into a RGB form, respectively, and the R, G, and B components of the digital watermark are embedded into the R, G, and B components of the image into which the watermark is embedded, respectively.

As described above, the present invention has the advantages in that it can identify the copyrighter of a produced image to cope with an illegal use or modification of the image. The human eyes cannot realize the difference between the images before and after embedding the digital watermark. The digital watermark embedded in the image according to the present invention cannot be deleted by others through a general image processing such as filtering and conversion, re-sampling, re-quantization, re-compression, improvement of the picture quality, adjustment of the illumination and brightness of a color, etc., or through a geometric distortion such as rotation, translation, cropping, scaling, zooming, etc. The digital watermark embedded according to the present invention can identify one copyrighter without fail when it is extracted from the image.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method of imbedding a hidden digital watermark into a produced image comprising the steps of:
repeatedly extending the digital watermark in a symmetric form and adjusting the extended digital watermark in the same size as an image into which the digital watermark is embedded;
decomposing the digital watermark image and the image into which the digital watermark is embedded into subbands;
properly adjusting pixel values of the subband-decomposed digital watermark image in accordance with the subband-decomposed image into which the digital watermark is embedded, and adding the pixel values of the subband-decomposed digital watermark image to pixel values of the subband-decomposed image into which the digital watermark is embedded; and
producing a final image into which the digital watermark is embedded by a subband synthesis.

2. The method as claimed in claim 1, wherein the step of repeatedly extending the digital watermark in the symmetric form repeatedly uses an extension of the digital watermark in right and downward directions, respectively, repeats the extension of the digital watermark until the extended digital watermark image becomes larger than the image into which the digital watermark is embedded, and adjusts the extended digital watermark image in the same size as that of the image into which the digital watermark is embedded by cutting off portions of the digital watermark image that exceed the size of the image into which the digital watermark is embedded.

3. The method as claimed in claim 1, wherein the step of decomposing the digital watermark image and the image into which the digital watermark is embedded into subbands performs a horizontal subband-decomposition the number of which corresponds to a multiplier of 2 and a vertical suband-decomposition the number of which corresponds to another multiplier of 2 by decomposing the images into 2 subbands in the horizontal and vertical directions, respectively, and then decomposing the decomposed subbands again in the same manner in the horizontal and vertical directions, respectively.

4. The method as claimed in claim 3, wherein the decomposing step is implemented by a low-pass filter and a high-pass filter for filtering one-dimensional signals in the horizontal and vertical directions.

5. The method as claimed in claim 1, wherein the step of adding the pixel values of the subband-decomposed digital watermark image to the pixel values of the subband-decomposed image into which the digital watermark is embedded is performed in a manner that the digital watermark image and the image into which the watermark is embedded are added at different rates in three different regions composed of an edge region, homogeneous region, and texture region of the image in consideration of a biological research result of a human visual system model in that human eyes react on the image with different sensibilities in the three regions.

6. The method as claimed in claim 1, wherein The step of producing the final image into which the digital watermark is embedded performs the subband synthesis in the reverse order of the step of decomposing the digital watermark image and the image into which the digital watermark is embedded into subbands.

7. A method of embedding a hidden digital watermark into a produced image comprising the step of embedding the digital watermark in accordance with color types of the digital watermark image and the image into which the watermark image is embedded.

8. The method as claimed in claim 7, wherein in case that the digital watermark image is black and white, and the image into which the watermark is embedded is black and white, the method as defined in claim 1 is used as it is.

9. The method as claimed in claim 7, wherein in case that the digital watermark image is black and white, and the image into which the watermark is embedded is color, the image into which the watermark is embedded is converted into a YUV form, and the digital watermark is embedded into a Y component.

10. The method as claimed in claim 7, wherein in case that the digital watermark image is color, and the image into which the watermark is embedded is black and white, the digital watermark image is converted into a YUV form, and a Y component of the digital watermark is embedded into the image into which the watermark is embedded.

11. The method as claimed in claim 7, wherein in case that the digital watermark image is color, and the image into which the watermark is embedded is color, both the digital watermark image and the image into which the watermark is embedded are converted into a RGB form, respectively, and the R, G, and B components of the digital watermark are embedded into the R, G, and B components of the image into which the watermark is embedded, respectively.
